(19) United States
(12) Patent Application Publication
(10) Pub. No.: US 2014/0067436 A1
(43) Pub. Date: Mar. 6, 2014

(54) SYSTEMS AND METHODS FOR DEMAND RESPONSE PAYMENT OPTIONS

(71) Applicants: Matt GODDARD, Mississauga (CA); Moru NUHAMOVICI, Thornhill (CA); David GAVIN, Dundas (CA)

(72) Inventors: Matt GODDARD, Mississauga (CA); Moru NUHAMOVICI, Thornhill (CA); David GAVIN, Dundas (CA)

(73) Assignee: TRAPEZE SOFTWARE INC., Mississauga (CA)

(21) Appl. No.: 13/603,886

(22) Filed: Sep. 5, 2012

(51) Int. Cl. G06Q 10/02; G06Q 30/02

(52) U.S. Cl. 705/5; 705/7.35

(57) ABSTRACT

Systems and methods for demand response transit systems using periodic passes as optional payment for transit services. Booking transit services may include determining if the passenger has a periodic pass and whether such periodic pass can be used to fully or partially pay for such booking. Historical costs and use of periodic passes, having certain characteristics, can further be used to set future prices of such periodic passes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Transit agencies typically have fixed route operations (where vehicles traverse a known route at a known frequency) and demand response operations (where vehicles have a non-repeating schedule for a given day).

Demand response transit systems have proven to be logistically difficult for receiving payments from riders, while remaining convenient for such riders. Historically, demand response riders have paid for their rides when they are picked up (using cash or some form of charge generally). More recently some agencies and service providers have allowed riders to keep accounts with the agency—enabling payments to be made on account.

While these developments improve convenience, they still require extra interactions by riders and oversight of accounts, credit card details, and the like.

Such difficulties have not been forced upon fixed route riders, who are able to purchase monthly passes

There thus remains a need for demand response payment options that reduce the number of interactions required of riders, while remaining profitable and analyzable by agencies.

### SUMMARY OF THE INVENTION

There is disclosed a method for demand response periodic pass based transit use comprising receiving, by a processor from a user input device, for temporary storage in a booking database, a request for a demand response periodic pass booking for a passenger, querying, by the processor with reference to a periodic pass database, whether the passenger has a periodic pass, determining, by the processor if querying returns a periodic pass, whether the periodic pass can be used for the requested demand response booking, and creating, by the processor, for permanent storage in a booking database, if determining returns an affirmation, a demand response periodic pass booking for the passenger.

The method may further comprise obtaining, by a processor, with reference to a periodic pass database, characteristics of the periodic pass, assembling, by a processor, with reference to a booking database, characteristics of the booking request, and comparing, by a processor, the characteristics of the periodic pass to the characteristics of the booking request. The characteristics of the periodic pass may comprise the name of the passenger, the time period the periodic pass is valid, the geographic bounds of eligibility to use the periodic pass. The method of claim 3 wherein the characteristics of the demand response periodic pass booking request comprise the name of the passenger, the date of the request, the pick up and drop off points, and whether a support person is to accompany the passenger.

The method may further comprise polling, by a processor in a funding source database, funding sources that may make up any discrepancies between the compared characteristics of the periodic pass and booking request.

There is further disclosed a method for demand response periodic pass based transit pricing comprising selecting, by a processor from a user input device, a periodic pass to price, obtaining, by a processor from a database of demand response periodic pass data, one or more characteristics of the periodic pass to price, determining, by a processor interacting with a database of demand response periodic pass data, one or more comparable periodic passes having one or more characteristics in common with the characteristics of the periodic pass to price, calculating, by a processor, for each comparable periodic pass the total cost of bookings made using the comparable periodic pass, arriving, by a processor, at an average price for the comparable periodic passes, and specifying the price for the periodic pass to price.

The method may further comprise comparing, by a processor with a database of demand response periodic pass data, funding sources that offset the total costs of the comparable periodic passes with funding sources presently available, and adjusting, by a processor, the price of the periodic pass to price based on the difference between funding sources available.

The characteristics of the periodic pass to price may comprise a time period, the age of the user of the periodic pass, and the user's funding sources or whether a support worker for the user of the periodic pass is covered by the periodic pass.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of a system for demand response payment options according to a non-limiting embodiment of the present invention;

FIG. 2 is a diagram of a method for creating a booking in a multi-payment method demand response transit system according to a non-limiting embodiment of the present invention;

FIG. 3 is a diagram of a method for determining whether a periodic pass is available, according to a non-limiting embodiment of the present invention;

FIG. 4 is a diagram of a method for determining whether a booking request is covered by a periodic pass, according to a non-limiting embodiment of the present invention;

FIG. 5 is a screenshot for accessing functionality and viewing data relating to periodic passes for demand response transit system.

### DETAILED DESCRIPTION OF THE INVENTION

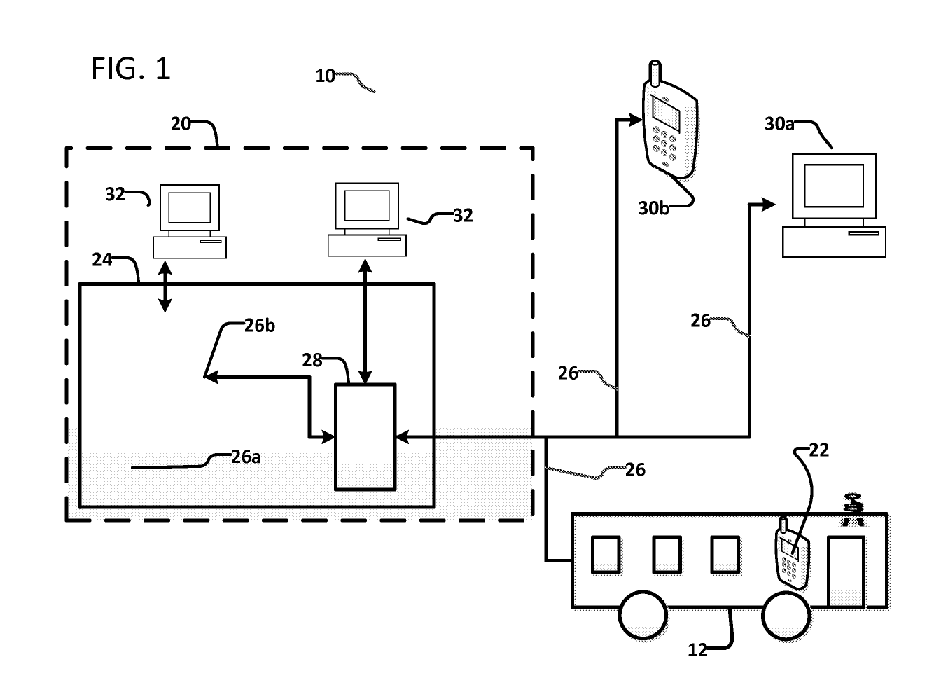

FIG. 1 is a diagram of a system 10 for demand response periodic passes comprising transit industry vehicle (TIV) 12, further comprising MDT 22, communication network 34, user computing devices 30a/30b, and demand response provider 20 (which may be a transit agency, for example) further comprising one or more control centers 32, and server 24 further comprising one or more databases 26 and application server 28.

It will further be appreciated that the systems, and elements thereof, described herein (such as MDT 22, control center 22b, and server 24) may be implemented using one or more computer apparatuses. Each of those computer apparatuses may have one or more computer readable media (such as RAM, ROM, hard drives or the like, as would be known in the art but are not shown herein) that may store a plurality of programming instructions, said programming instructions executable by the computing apparatus, such as by one or more processors, and able to communicate with the computer readable media including databases 26, data structures, data and tables as described herein.

TIV 12 is a vehicle that provides, or relates to the provision of, demand response transit services. TIV 12 may include buses, para-transit specific vehicles, taxis, supervisory vehicles (such as cars or vans driven by supervisors) or a light rail/TRAM vehicles. TIV 12 has many systems running thereon, as known in the art, such as engines, brakes, audio announcement technology, and one or more of a variety of fare collection systems, as further described herein. When a driver drives TIV 12 to a pickup location for a passenger making a booking with a periodic pass, the driver may use MDT 22 to confirm the periodic pass (or other aspects of the booking); such confirmation may include interacting with UCD 30 or a physical periodic pass. Of course it is to be understood that such confirmation may occur at the time of booking, meaning that no confirmation or validation is required upon pickup.

MDT 22 is a computing device that may take user input (such as keystrokes, clicks, touch inputs, and the like) and provides the user interface to functionality relating to the provision of demand response transit services. MDT 22 may often be located on TIV 12, but may be removable therefrom. Exemplary MDTs 22 include mobile phones, tablets, laptop (including ruggedized laptops), vendor specific MDTs (such as Android™ or Apple™ products). Operators of TIV 12, or supervisors, may be some of the primary users of MDTs 22. MDT 22 may be able to read the physical periodic passes (not shown, but as known to those of skill in the art) such as via magnetic swipe, RED, chip technology, QR codes, or the like.

Demand response provider (DRP) 20 may be any provider of demand response transit services, and may be a transit agency (that may also offer other services such as fixed route services). DRP is depicted as having its components in one location but may be dispersed, and TIV 12 may be part of DRP 20. DRP may have one or more servers or other computer apparatuses to implement the functionality and services it is to provide.

DRP 20 may have one or more servers 24 which may have one or more processors or application servers 28 and one or more databases 26 such as periodic pass database 26a (storing all data relating to purchasers of periodic passes and the use thereof) and booking database 26b (storing all bookings that have been made).

Control center 32 may be at a transit agency, and may have further systems that form part of the overall system enabling one or more forms of transportation for a transit agency. Control center 32 may be considered an MDT 22, despite possibly having greater systems as well.

User computing devices (UCD) 30a/30b may be substantially any computing device that allows a passenger (or other person) make a booking request and eventually a booking. Such booking requests may be via interactions with application server 28, for example. UCD 30 may be a PC, tablet, smart phone, and the like. UCD 30 may substantially “carry” the periodic pass as an electronic ticket. As such MDT 22 may interact with UCD 30 to confirm the presence of the periodic pass, in some embodiments of the present invention. In one embodiment, for example, UCD 30 may be a phone providing voice or touch tone services that can be used to create the booking request via one or more interactions with application server 28 and/or a user entering data into application server 28.

Communication network 34 may enable communication between different parts of system 10. Communication network 34 may be substantially any public or private network, wired or wireless, and may be substantially comprised of one or more networks that may be able to facilitate communication between themselves.

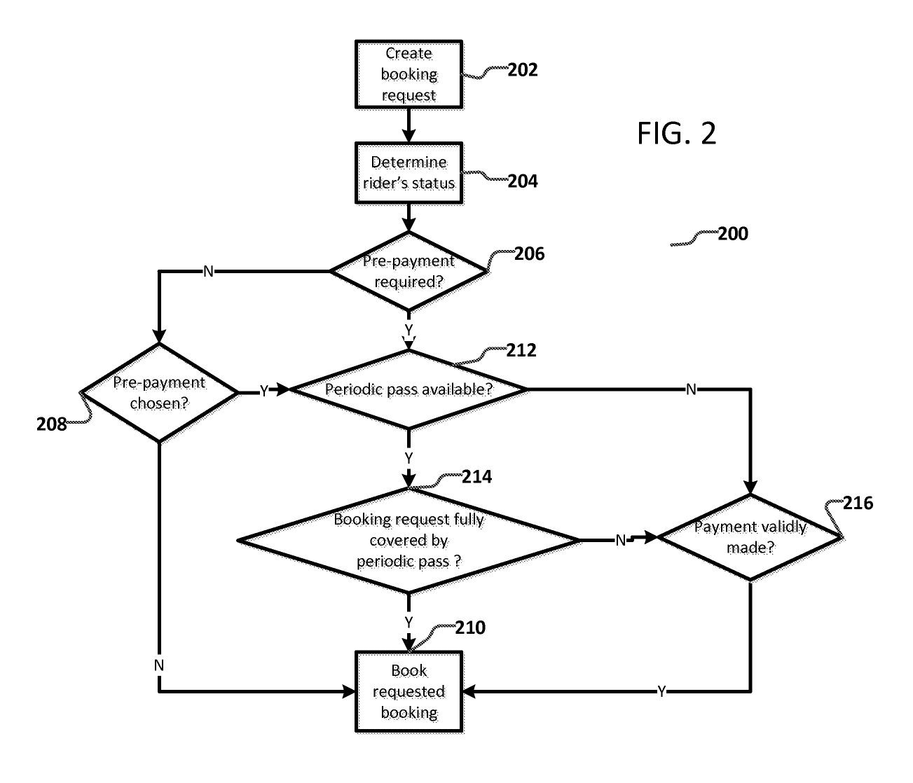

FIG. 2 is a diagram of a method 200 for creating a booking in a multi-payment method demand response transit system.

Method 200 begins at 202 where a booking request is created. A booking request may comprise a trip including one or more rides, on one or more TIV 12, to get one or more persons from a first location (such as a pick up location) to a second location (such as a drop off location). Creating a booking may substantially comprise providing the required information to specify the trip that is to be taken. Such information may comprise at a minimum, for example, a pickup location and date/time, a drop-off location and date/time, and a rider's identifier (name or ID number for example). Creating a booking may be via using MDT 22, control center 22b or user computing device 30 and accessing functionality of application server 28 (such as via webpages).

Method 200 continues at 204 where the rider's status (which may be their “prepayment setting” as in 510) is determined. A rider's status, as described herein, may be one of “Prepayment required”, “Prepayment allowed” or “Prepayment not allowed”.

At 206, a determination is made whether pre-payment is required before the booking request can cause a booking to be made. The determination at 206 may be based on several factors, including the rider/user, the rider's status, the trip (how long, how many stops, what vehicles will be used, and the like), laws or regulations, policies of the agency, and the like, and whether the rider's account balance is above zero. For example, if a rider's status is “Prepayment allowed” and the trip is short and inexpensive then pre-payment may not be required. If a trip is long and expensive, and the rider's status is “No Credit” then pre-payment may be required. Alternatively, an agency may simply require all demand response trips be prepaid.

If prepayment is not required at 206 then method 200 continues to 208 where a rider (or other person creating the booking request; either a “booker”) can select to make a prepayment, even though it is not required. If the booker does not wish to prepay then method 200 continues to 210 and the booking request is converted into a booking. Such conversion, and the resulting booking, means that the rider will be picked up at the date/time and location specified in the booking request, and will be dropped off at the date/time and location specified in the booking request.

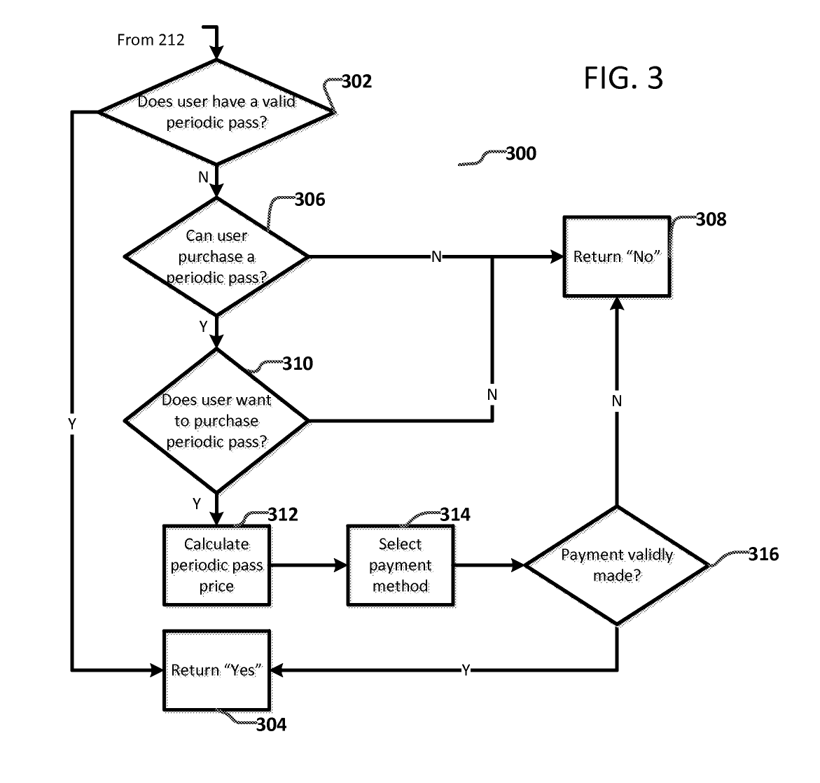

If at 208 a booker desires to prepay, or if prepayment is required at 206, method 200 continues to 212 where a determination is made whether a periodic pass is available. Such availability determination may involve determining whether the rider already has a periodic pass, or is eligible to purchase one, for example. Further details relating to 212 may be found in method 300 in FIG. 3.

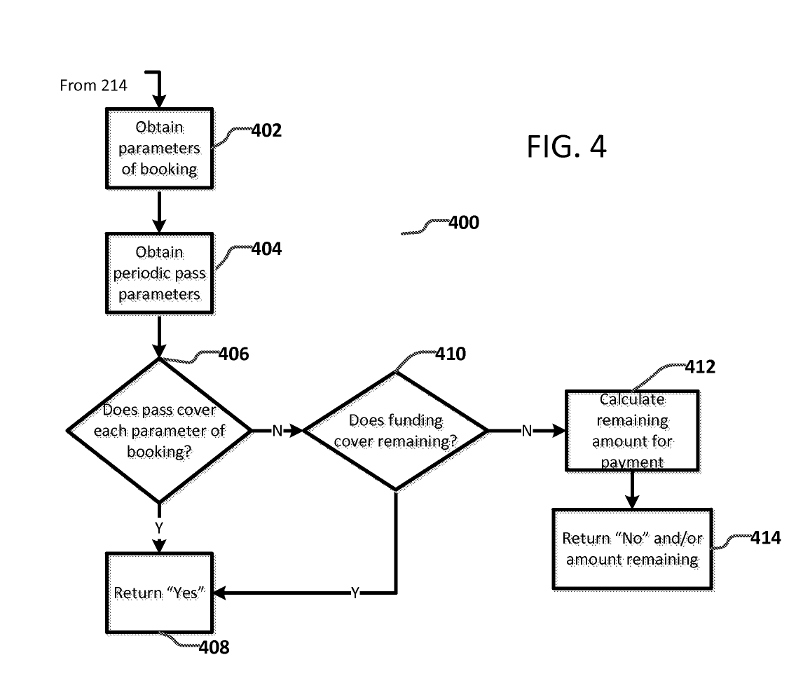

Continuing from 212, if a periodic pass is available then method 200 continues to 214 to determine whether the booking request is covered by the periodic pass. Such coverage determination may involve comparing characteristics of the periodic pass to characteristics of the trip and/or rider, for example. Further details relating to 214 may be found in method 300 in FIG. 4.

If the booking request is covered by the periodic pass then method 200 continues and terminates at 210 with a booking request resulting in a booking. If the booking request is not covered by the periodic pass at 214 (and prepayment was required at 206) then method 200 continues to 216 for payment to be made. If payment is validly made at 216 then method 200 continues and terminates at 210 with a booking request resulting in a booking. Payment validity simply refers to the agency receiving the correct compensation for the booking request (from any source), the appropriate security that it will receive such compensation, or some similar assurance.

FIG. 3 is a diagram of a method 300 for determining whether a periodic pass is available. Similar to methods 200 and 400, method 300 may be implemented by one or more computing devices (such as MDT 22, control center 22b or user computing device 30) and may be initiated by one or more users of such devices.

Method 300 begins at 302 (having arrived there from 212) to query whether the user/rider has a valid periodic pass. A valid periodic pass may be one that applies to the date/time in question (for example, if it is a monthly pass, are we still in that month?), and applies to the rider (for example, if it is a senior's pass, is the rider a senior?).

If the rider does not have a periodic pass then a query is made whether one can be purchased at 306. If one cannot be purchased then method 300 terminates at 308 and returns a “No” value to method 200. Otherwise method 300 continues to 310 to query whether the rider desires to purchase a periodic pass. If they do not then method 300 terminates at 308 and returns a “No” value to method 200. Otherwise method 300 continues to 312 to calculate the price of a periodic pass. The cost may be determined, for example, by several factors, such as how long the period is to cover, the age and income of the rider, the scope of the pass (local, regional, multi-mode or simply demand response land vehicles, etc), and other factors.

At 314 a payment method is selected and if payment is validly made at 316 then method 300 proceeds to 304 and returns a “Yes” value. Otherwise method 300 continues to 308 and returns a “No” value.

FIG. 4 is a diagram of a method 400 for determining whether the booking request is covered by the periodic pass.

Method 400 begins at 402 (having arrived there from 214) where parameters of the booking request are obtained. Such parameters may include, for example, the number and identity of riders, the number of stops, zones, modes of transport, the date, and the like. At 404, similarly, periodic pass parameters are obtained, for example what period it covers, the rider(s) it covers, how many zones or stops it covers, and any other limitations.

At 406 method 400 determines whether any parameters of the booking request fall outside what is covered by the periodic pass (for example the booking request is for a regular adult and the periodic pass is only for seniors).

If some parameter is not covered at 406 then a query is made whether funding (or some other source) can cover the outstanding amount or parameter. For example, if the periodic pass only covers up to a certain distance for a booking request, and the booking request exceeds that distance, then perhaps a government senior's program will pay for the cost of the trip that represents the excess.

If such funding coverage is available then method 400 proceeds to 408 and returns a “Yes” value. If it is not available then method 400 proceeds to 412 to calculate the amount remaining or reason for lack of coverage. After 412, method 400 proceeds to 414 and returns a “No” value, and/or the amount remaining (or reason for lack of coverage).

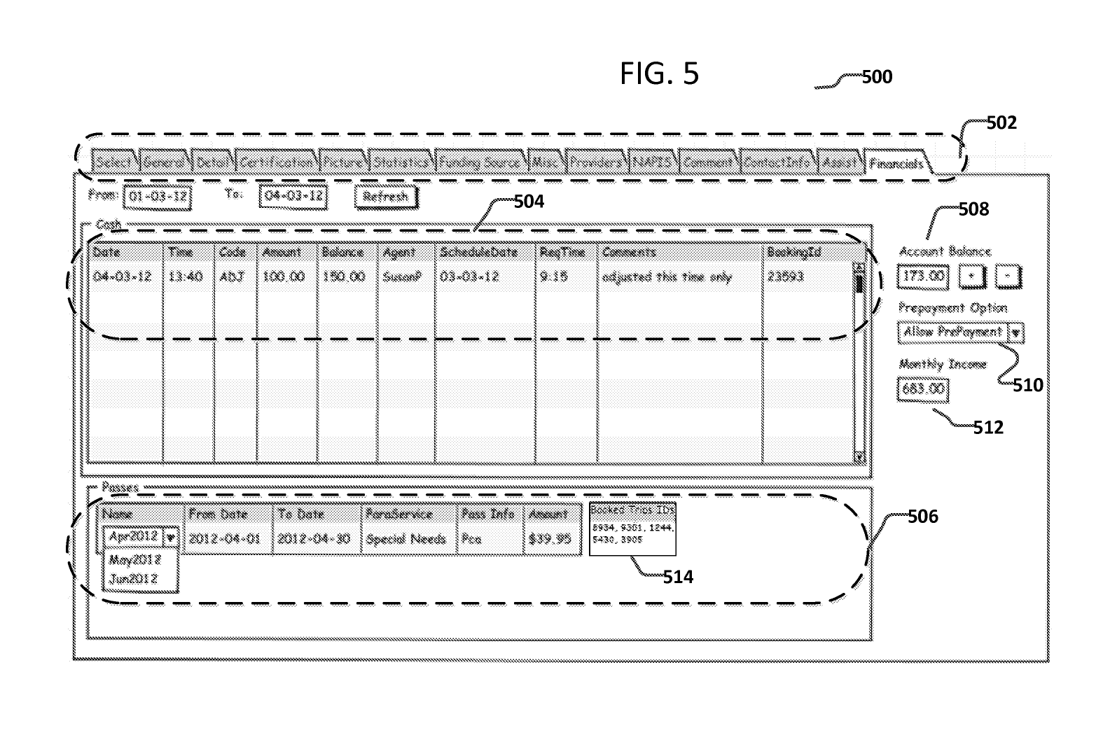

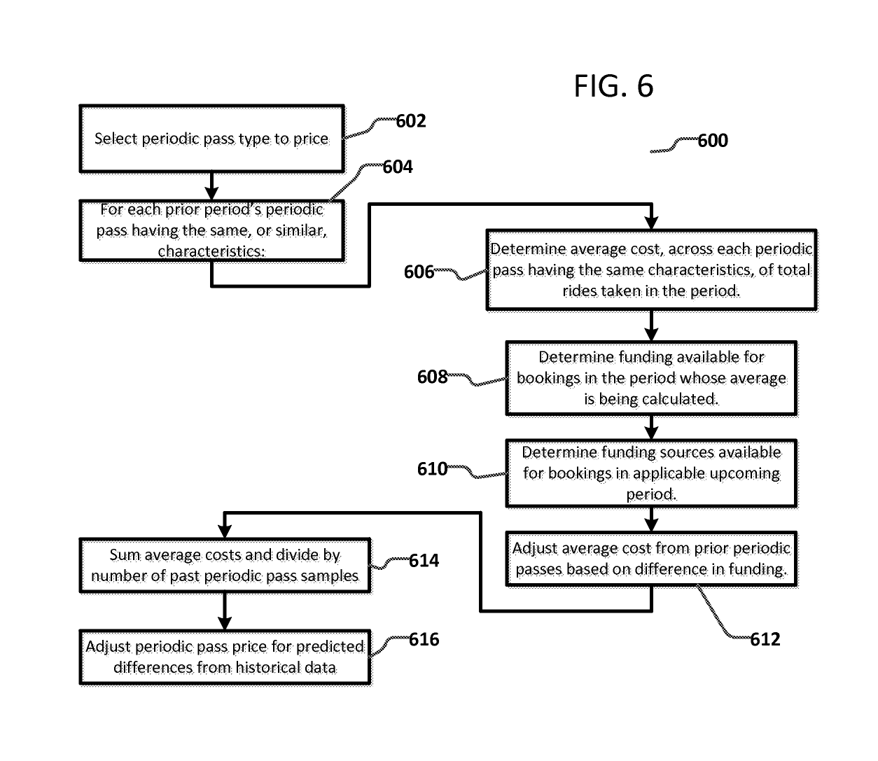

FIG. 5 is a screenshot 500 for accessing functionality and viewing data relating to periodic passes for demand response transit system, comprising tabs 502, balance details 504, periodic pass data 506 further comprising trip IDs 514, balance 508, prepayment setting 510, and rider characteristic 512.

Screenshot 500, and others (such as may be accessed via tabs 502) may reside on, or be created by, system 10 and application server 28 in particular. Any such screenshots may allow accessing functionality and data of system 10, such as via MDT 22, control center 22b, and user computing devices 30.

Balance details 504 may provide the underlying information to substantiate balance 508. A rider may top up their account, or charge their account prior to paying the balance via credit card for example. Balance details 504 and balance 508 may provide the rider the information to monitor and stay current with their balance.

Prepayment setting 510 may specify the rights a rider has to prepay, as described herein. For example, a particular rider may have to prepay if their credit worthiness is low. Although shown in FIG. 5 as a drop-down list, this may depend on who is accessing screenshot 500—an agency user may be able to select between options while the user may only be able to view their setting.

Rider characteristic 512 is one of a potential one or more rider characteristics, as described herein. As shown in FIG. 5 the characteristic may be their monthly income, which may contribute to available funding sources (which may be viewable via tabs 502, “Funding Source”), their prepayment setting 510.

Periodic pass data 506 may display data relating to the one or more periodic passes purchased by, or related to, a rider. Such data may be stored in one or more data structures on databases 26 on server 24. Such data may include, for example, the name of the periodic pass, its duration or validity dates, the type of coverage it provides (how many people, age ranges, vehicles that may be used, number of times a month or day, etc), the cost (including whether the cost is partially paid by funding sources), and booking IDs 514 that were booked using the particular periodic pass. The booking IDS 514 may of course be connected to (such as via links) to data relating to the bookings.

Because bookings must be made in demand response transit systems (as opposed to fixed route transit, which requires no bookings), there is a desire to track bookings that were covered (or partially covered) by periodic passes. This may allow agencies to continually monitor use of the periodic pass to ensure that clients are being provided suitable periodic pass options, while maintaining a suitable level of profitability for the agency.

It is to be understood that many other screenshots could be used to display and access the functionality and data in FIG. 5 and that many other screenshots could be used to display and access other functionality described herein.

FIG. 6 is a diagram of a method 600 for determining a price for a demand response periodic pass.

Method 600 begins at 602 where a particular periodic pass type is selected to determine a price for. Such selection may include, the age (such as adult, child or senior), geographic location (part of a city, an entire city, an entire region), length of time (weekly, monthly, quarterly, summer pass, yearly), whether special services are required (wheelchair transport for example), whether a support worker is required to accompany the passenger (passholder).

At 604 method 600 continues to analyze all periodic passes, which may be known as comparable period passes, having the same, or similar characteristics as those in 602.

At 606 the average cost of the rides provided under for each periodic pass from a given period is calculated. For example, if the pass is a monthly senior's pass for the month of May in 2012, May's senior's passes in 2011 will be considered and each senior with such a pass will have their booking costs added. Such costs will then be summed and divided by the number of seniors in 2011 having such a periodic pass. Of course ride costs for each such pass could be added to arrive at a cost for each comparable pass, before summing and obtaining an average.

At 608 the finding sources or overall funding available for the periodic pass is considered (for example, what funding sources were available for seniors in 2011). Each periodic pass may have been subject to $50 of funding, meaning that the periodic pass price would otherwise have been $50 higher. Of course this can be converted to a reduction per booking, if desired, as all bookings made under a particular periodic pass may be stored in periodic pass database 26a. Funding sources may include government rebates and discounts (local, municipal, provincial, state, federal, etc), private or public health insurance, or other funding sources.

As funding sources may vary over time, at 610 the funding sources or overall funding that will be available for the new periodic pass is considered.

If such funding sources would, on average, only serve to decrease the cost of the bookings by $40 then the periodic pass price may be increased by $10 for example. This would occur at 612.

At 614, after all relevant historical periodic pass data has been gathered, the average costs may be summed and divided by the sample size.

At 616 a further adjustment may be made to account for predicted differences in bookings that may result in differences in periodic pass booking costs. For example, if more seniors are expected to buy passes, and hence economies of scale are expected, then the periodic pass price for seniors may be slightly decreased.

Although many other approaches to setting the price of periodic passes are possible, they are considered within the scope of the present invention when they include at least one of: comparison to old prices, old costs actually incurred, and prediction of future use.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A method for demand response periodic pass based transit use comprising:
receiving, by a processor from a user input device, for temporary storage in a booking database, a request for a demand response periodic pass booking for a passenger;
querying, by the processor with reference to a periodic pass database, whether the passenger has a periodic pass;
determining, by the processor if querying returns a periodic pass, whether the periodic pass can be used for the requested demand response booking; and
creating, by the processor, for permanent storage in a booking database, if determining returns an affirmation of a demand response periodic pass, a booking for the passenger.

2. The method of claim 1 wherein the determining further comprises:
obtaining, by a processor, with reference to a periodic pass database, characteristics of the periodic pass;
assembling, by a processor, with reference to a booking database, characteristics of the booking request; and
comparing, by a processor, the characteristics of the periodic pass to the characteristics of the booking request.

3. The method of claim 2 wherein the characteristics of the periodic pass comprise the name of the passenger, the time period the periodic pass is valid, the geographic bounds of eligibility to use the periodic pass.

4. The method of claim 3 wherein the characteristics of the demand response periodic pass booking request comprise the name of the passenger, the date of the request, the pick up and drop off points, and whether a support person is to accompany the passenger.

5. The method of claim I wherein the determining further comprises:
polling, by a processor in a funding source database, funding sources that may make up any discrepancies between the compared characteristics of the periodic pass and booking request.

6. A method for demand response periodic pass based transit pricing comprising:
selecting, by a processor from a user input device, a periodic pass to price;
obtaining, by a processor from a database of demand response periodic pass data, one or more characteristics of the periodic pass to price;
determining, by a processor interacting with a database of demand response periodic pass data, one or more comparable periodic passes having one or more characteristics in common with the characteristics of the periodic pass to price;
calculating, by a processor, for each comparable periodic pass the total cost of bookings made using the comparable periodic pass;
arriving, by a processor, at an average price for the comparable periodic passes; and
specifying the price for the periodic pass to price.

7. The method of claim 6 further comprising:
comparing, by a processor with a database of demand response periodic pass data, funding sources that offset the total costs of the comparable periodic passes with funding sources presently available; and
adjusting, by a processor, the price of the periodic pass to price based on the difference between funding sources available.

8. The method of claim 7 wherein the characteristics of the periodic pass to price comprise a time period, the age of the user of the periodic pass, and the user's funding sources.

9. The method of claim 8 wherein the characteristics of the periodic pass to price further comprise whether a support worker for the user of the periodic pass is covered by the periodic pass.
